(19) United States
(12) Patent Application Publication
(10) Pub. No.: US 2024/0336537 A1
(43) Pub. Date: Oct. 10, 2024

(54) BIOSTIMULANT COMPOSITION BASED ON MONOPOTASSIUM PHOSPHATE IN ACID FORM

(71) Applicant: VIVAGRO, MARTILLAC (FR)

(72) Inventor: Fabrice LEMARCHAND-GASNAULT, AMBARES ET LAGRAVE (FR)

(21) Appl. No.: 18/294,664

(22) PCT Filed: Aug. 4, 2022
(86) PCT No.: PCT/EP2022/071994

§ 371 Date: Feb. 5, 2024

(30) Foreign Application Priority Data
Aug. 5, 2021 (FR) FR2108511

(51) Int. Cl. C05B 7/00; A01N 59/26; A01P 3/00; A01P 21/00; C05G 3/60

(52) U.S. Cl. CPC C05B 7/00; A01N 59/26; A01P 3/00; A01P 21/00; C05G 3/60

(57) ABSTRACT

The present invention relates to the use, as a biostimulant and/or elicitor and/or nutritional product and/or to combat pathogens, of a monopotassium phosphate-based composition in aqueous and acid form, and to a method for treating crops.

### TECHNICAL FIELD

The invention relates to the use, as a biostimulant and/or elicitor and/or nutritional product and/or to combat pathogens, of a monopotassium phosphate-based composition in aqueous and acid form, and to a method for treating crops.

### PRIOR ART

Nitrogen, phosphorus and potassium are the three main nutrients required for plant growth, particularly the growth of leaves, stems and fruit. Plants also need secondary elements such as magnesium, calcium and trace elements (copper, zinc and manganese, for example).

Soils naturally contain all the elements needed for plant growth. However, they are generally not present in the soil in sufficient quantities or in forms to support optimal plant growth and yield.

It is therefore appealing to supplement soils with a product containing such nutrients and capable of being assimilated by plants. The use of so-called natural fertilizers, which are organic fertilizers derived from animal or plant matter such as manure, slurry and compost, can at least partially remedy a deficiency of these nutrients.

Later, discoveries in plant nutrition led to the development of so-called chemical fertilizers. As a result, natural fertilizers have been supplemented or even partly replaced by chemical fertilizers, which have significantly improved yields per hectare. These fertilizers, based on chemical constituents in specific quantities, enrich the environment through soil or foliar application, thus promoting plant growth. Fertilizers are complex to varying degrees and may comprise major fertilizing elements that require large quantities of input for the plant (nitrogen, phosphorus, potassium), secondary elements (magnesium, calcium) or trace elements such as copper, iron, manganese, zinc, cobalt, molybdenum (typically in the form of molybdate) and boron (typically in the form of borate).

These include phosphorus-based fertilizers. Phosphorus (P) is a major element useful to plants for optimal growth. It is present in various forms, including phosphates, phosphites and phosphonates. Phosphates are considered fertilizers, as they provide nutrients in the form of phosphorus that plants can assimilate.

Phosphite- or phosphonate-based products have a dual function on crops: on the one hand, they act, in theory, as a source of phosphorus; on the other, they act, in the form of phosphite ion (PO3⁻), as a stimulant of plant self-defense mechanisms against pathogenic fungi in roots, collars, branches, fruits, etc. Phosphites in the form of phosphorous acid or phosphonic acid are authorized as plant protection products. They act systemically in the plant, leaving residues in the form of phosphite ions in treated crops. In most cases, they are applied by foliar means.

However, such products cannot be used as fertilizers as explained in EC regulation 2019/1009. This is because they do not represent a source of phosphates available for the plant, nor do they improve its growth, and are therefore not fertilizers.

Also known are monopotassium phosphate-based products such as Monopotassium Phosphate 0-52-34 (MKP), and dipotassium phosphate-based products such as Dipotassium Phosphate 0-41-54 (DKP). Such products may act as fertilizers, but they have no eliciting properties and therefore cannot activate/stimulate the plant's natural defenses. What's more, they come in solid form and, when dissolved, contain very little or no phosphoric acid. They are applied in large quantities with localized soil placements that allow greater absorption than foliar applications. Its relatively neutral pH avoids stability problems in wet conditions, limits soil acidification, and facilitates the spreading of the product on the ground in granulated form.

There is therefore a need for a new nutritional product and elicitor that provides phosphorus to the plant and overcomes the drawbacks of the prior art, in particular avoiding the systematic presence of phosphite residues, but also providing a phosphate comprising large quantities of phosphoric acid in liquid form while having good elicitation, biostimulation, nutrition and pathogen control efficacy.

This is the objective of the present invention.

### SUMMARY OF THE INVENTION

In response, the invention proposes a new composition based on aqueous monopotassium phosphate, in liquid form, the pH of said composition being between 1 and 4, which makes it possible to obtain an elicitation product and a nutrition product, preferentially by foliar application. At this pH, monopotassium phosphate is in the form of phosphoric acid and/or dihydrogen phosphate.

The inventors thus discovered that such a composition showed very good results when used as an elicitor, biostimulant and nutritional product, but also, surprisingly, in controlling pathogens such as late blight or scab on several plant species.

Thus, the invention concerns a composition comprising a mixture of phosphoric acid and aqueous dihydrogen phosphate in liquid form, characterized in that the pH of said composition is between 1 and 4. Advantageously, the mixture consists of phosphoric acid, dihydrogen phosphate and water. In particular, it was found by the inventors that the mixture showed good results when used as a biostimulant and/or elicitor and/or nutritional product and/or for controlling pathogens.

Finally, the invention also concerns a preparation method and a culture treatment method.

Other features and advantages will become apparent from the detailed description of the invention, the examples and the figures that follow.

### BRIEF DESCRIPTION OF THE FIGURES

FIG. 1 shows the results of treatment of vine leaves with the composition according to the invention, alone or in combination with Maniflow, a product based on 124 g/L Bordeaux mixture.

FIG. 2 shows the results of treatment of grape bunches with the composition according to the invention alone or in combination with the Maniflow product.

FIG. 3 shows the results of treatment of apple fruit with the composition according to the invention in combination with a contact product, compared with a baseline treatment and an untreated control.

FIG. 4 shows the results of treatment of apple tree defoliation with the composition according to the invention in combination with a contact product, compared with a baseline treatment and an untreated control.

FIG. 5 shows the results of the proteomic study on the activation of alternative mechanisms to generate sufficient additional ATP for growth processes, following the activation of plant defenses.

FIG. 6 shows the results of the proteomic study demonstrating greater availability of phosphate for nutrition, plant stimulation and pathogen control.

FIG. 7 shows the results of the proteomic study demonstrating the improvement in the overall capacity to counteract pathogen damage.

### DETAILED DESCRIPTION OF THE INVENTION

### Composition

The object of the present invention is therefore a composition based on aqueous monopotassium phosphate in liquid form, the pH of said composition being between 1 and 4.

In particular, monopotassium phosphate according to the invention in acid and aqueous form is a mixture of phosphoric acid and dihydrogen phosphate, preferably the mixture consists of phosphoric acid, dihydrogen phosphate and water. The formula is as follows.

H₃PO₄₍ₛ₎+H₂O₍ₗ₎→+H₃O_{(aq)}⁺+H₂PO_{4(aq)}⁻ [Formula 1]

Monopotassium phosphate in acid form according to the invention of Formula 1 thus has a pH of less than 4, preferentially between 1 and 4, more preferentially the composition according to the invention has a pH chosen from 1.7; 1.8; 1.9; 2.0; 2.1; 2.2; 2.3; 2.4; 2.5; 2.6; 2.7; 2.8; 2.9; 3.0; 3.1; 3.2; 3.3; 3.4; 3.5; 3.6; 3.7; 3.8; 3.9; 4.0; and combinations thereof. More preferentially a pH below 2.5. Even more preferentially a pH below 2.15 (+0.01).

For the purposes of the invention, “pH equal to X” or “pH of X” means a pH equal to X plus or minus 0.1. For the purposes of the invention, pH equal to 2.5 means pH equal to 2.5 plus or minus 0.1.

At acidic pH (pH below 7), the predominant forms of monopotassium phosphate in solution are phosphoric acid and dihydrogen phosphate. More preferably, when the pH is below 2.15, phosphoric acid (H₃PO₄) accounts for more than 50% of the mixture. When the pH is between 2.15 and 4, dihydrogen phosphate (H₂PO₄) accounts for more than 50% of the mixture. So, the lower the pH, the greater the quantity of phosphoric acid in the mixture, making phosphate more readily available.

Advantageously, the monopotassium phosphate-based composition according to the invention therefore has a pH of less than 4 and more preferentially less than or equal to 2.5. The composition thus comprises more than 50% in the mixture of the form (H₃PO₄) when the pH is below 2.15. Such a mixture thus makes it possible to overcome the drawbacks of the prior art and to obtain elicitation, biostimulation, nutrition and pathogen control properties that are particularly sought-after in the context of the present invention.

The use of an acid form of monopotassium phosphate has never been considered for elicitation purposes. This is because biologically, an acid pH will naturally be unfavorable to living organisms, and in particular an acid pH will disturb plants. Surprisingly, the inventors discovered that the composition according to the invention not only produces an elicitation product, but also maintains fertilizer qualities thanks to the presence of an available phosphate form. Said composition can therefore act as a fertilizer while also combining elicitation and biostimulation properties without the presence of phosphite residues.

In a preferred embodiment, the composition according to the invention is applied in solution at a concentration of between 0.4% and 5%, preferentially between 1% and 5%, in water. In a particularly preferred embodiment, when the composition according to the invention is dissolved at 1% in water and the pH is equal to 2.15 (plus or minus 0.5), the acid form, i.e. phosphoric acid, represents 295 g/L of the mixture.

According to another particularly preferred embodiment of the invention, the inventors have selected a particularly high P/K ratio which significantly improves the properties of the composition according to the invention.

The P/K ratio improves the stimulating and nutritive qualities and the availability of phosphate.

Preferably, the P/K ratio of the composition is between 5.5:1 and 7:1, preferentially between 6:1 and 6.4:1, even more preferentially the P/K ratio is equal to 6.2:1.

Such a ratio makes phosphate more available for nutrition, plant stimulation but also pathogen control.

For example, monopotassium phosphate such as Monopotassium Phosphate 0-52-34 (MKP) sold by Prayon and dipotassium phosphate such as Dipotassium Phosphate 0-41-54 (DKP) sold by Haifa have P/K ratios of 1.52 and 0.75 respectively. Such ratios do not allow for satisfactory phosphate availability and therefore present lower efficacy results than those of the composition according to the invention. They are therefore exclusively nutritional products, not elicitation products.

Given the specific formulation of the composition according to the invention, said composition comprises neither phosphorous acid (H₃PO₃₋), nor phosphonic acid (H₂PO₃₊). The absence of these molecules is advantageous in the context of the present invention, as it avoids the presence of undesirable effects such as residues, including on products from the treated crop.

Phosphorous acid and phosphonic acid also mean residues of these molecules, such as H₃PO₃ and PO₃. By way of example, these forms of phosphorous acid or phosphonic acid can come in various types of potassium, sodium or aluminum salt.

Preferentially, the composition according to the invention does not comprise the HPO4 and PO₄ form.

In one embodiment, the composition comprises a mixture consisting of phosphoric acid, dihydrogen phosphate and water.

In another variant, the composition consists of a mixture consisting of phosphoric acid, dihydrogen phosphate and water.

Advantageously, the composition according to the invention may comprise other ingredients in combination with the mixture according to any of the preceding embodiments, enabling the performance of the product to be improved. The composition may thus comprise zinc and/or manganese and/or silica. Zinc is a catalyst in the production of ATP, which is essential for metabolic energy. Potash activates photosynthesis, while manganese regulates nitrogen assimilation and controls the plant's chlorophyll activity.

Preferentially, the zinc is zinc bis(dihydrogen phosphate) or zinc sulfate.

Preferentially, silica acts as a nutrition regulator when it is in monomeric form and is therefore assimilable by the plant.

When the composition also comprises zinc, the concentration of phosphoric acid can be between 5 and 10% and the concentration of zinc bis(dihydrogen phosphate) can be between 5 and 10%.

Preferentially, the mixture can also be used in combination with at least one other product. Thus, the composition may also comprise a plant protection product and/or a biostimulant and/or a fertilizer and/or an adjuvant. The combination of the mixture according to the invention and a plant protection product and/or a biostimulant and/or a fertilizer and/or an adjuvant may be in the form of a single composition or in the form of an extemporaneous preparation.

By “adjuvant” in the sense of the invention we mean a product that does not have any biocidal or antiparasitic activity (that is insecticide or fungicide, for example), added to the composition to improve its efficacy. For example, the adjuvant can be used to improve the spraying quality of the agricultural product or its spreading properties.

By way of example, the plant protection product used in combination with the composition according to the invention is chosen from fungicides.

Fungicides are substances designed to eliminate fungi, preferentially a copper-based fungicide. Fungicides have several different modes of action:
those that affect respiratory processes and energy production, including those that target inhibition of spore germination, such as multisite fungicides, and those that target inhibition of mitochondrial complex II or III, such as strobilurins or SDHIs,
those that affect membrane permeability by disrupting lipid synthesis,
those that affect amino acid or protein biosynthesis,
those that affect nucleic acid biosynthesis and/or cell division and microtubules and/or cell signaling,
those that stimulate plant defense reactions.

By way of example, the biostimulant product used in combination with the composition according to the invention is chosen from purified algae extracts, complex plant extracts, purified plant extracts comprising proteins, polysaccharides, lipids and polyphenols, including anthocyanins, flavonoids and stilbenes such as resveratrol; purified macroorganism extracts; live microorganisms; purified microorganism extracts; and complex algae extracts.

By way of example, the fertilizing product used in combination with the composition according to the invention is chosen from substances, or mixtures of substances, of natural or synthetic origin, used in agriculture to improve soils and fertilize cultivated plants. They comprise fertilizers, organic soil amendments and mixtures thereof.

By way of example, the fungicidal product used in combination with the composition according to the invention is chosen from triazolinthiones (e.g. prothioconazole), triazoles (e.g. tebuconazole), the family of succinate dehydrogenase inhibitors (SDHI), strobilurins, spirocetalamines, dithiocarbamates (e.g. maneb, mancozeb, metiram zinc), phthalimides (e.g. folpet, captan), guanidines (e.g. dodine, guazatine triacetate) and/or quinones (Dithianon), copper fungicides.

In particular, the composition according to any of the preceding embodiments is applied to plants as a biostimulant and/or elicitor and/or nutritional product and/or to control pathogens.

Thus, the invention also relates to the use of the composition according to any of the preceding embodiments, in particular the monopotassium phosphate-based composition in aqueous form intended to be applied to plants as a biostimulant and/or elicitor and/or nutritional product and/or for controlling pathogens, characterized in that the pH of said composition is between 1 and 4. Preferentially, the invention relates to use as a biostimulant and elicitor and nutritional product and for combating pathogens.

Preferentially, the composition enables the following uses:
stimulate the plant's defenses, and/or
boost the plant's metabolism, and/or
increase the redox balance, and/or
increase cellular homeostasis, and/or
increase energy production.

The elements provided by the composition according to the invention thus enable the plant to grow, despite a decrease in the abundance of proteins linked to photosynthesis in the 2-4 days following application of the invention, which is surprising in the plant kingdom. However, the composition according to the invention allows a concomitant increase in proteins linked to homeostasis, energy management, and sugar transport. This reduction does not therefore imply a cessation of growth, demonstrating that plants grown under normal conditions, or diseased, and treated with the composition according to the invention, activate alternative mechanisms to generate sufficient additional ATP for growth processes, following the activation of defenses.

In this way, the composition according to the invention acts as an elicitor and biostimulant, thereby combating plant pathogens.

Surprisingly, the inventors have observed that the composition according to the invention can stimulate plant defenses for up to 9 days, preferentially 4 days after applying said composition. Such a duration is particularly advantageous in the context of the present invention for the following reasons. Protection against pathogens by elicitation provides a response against pathogens developed by the plant itself. This frees us from the need to use synthetic or mineral chemicals (copper products), which among other disadvantages entail residues. The plant-induced response spreads this reduced sensitivity throughout the plant, including during the vegetative growth phases, thus protecting the plant without the need for further synthetic chemical treatments during the plant's growth phases. Last but not least, such a response makes it possible to avoid adverse climatic conditions such as rain. Indeed, contact plant protection products have the disadvantage of being washed off in heavy rain.

### Preparation Method

The composition can be prepared according to the following method:
Mix H₃PO₄ in water H₂O in a tank,
Add KH₂PO₄ and dissolve
If necessary, adjust the pH to a value between 1 and 4 by adding KOH or H₃PO₄ to the mixture

### Crop Treatment Method

The invention also relates to a method for treating crops, in particular vines, arboriculture (pome fruits, stone fruits, nuts, berries including strawberries), cereals (wheat, barley, corn), oil and protein crops, vegetable and fruit crops (fruit vegetables, leaf vegetables and root vegetables), tropical crops, ornamental crops and turf to stimulate said crops, comprising the application of the composition according to the invention based on aqueous monopotassium phosphate in liquid form with a pH of between 1 and 4, i.e. a mixture of phosphoric acid and dihydrogen phosphate, applied at a rate of 1 to 8 L per hectare or at a rate of 50 to 3000 L per hectare.

Preferentially, the invention relates to a method of treating crops to stimulate plant defenses, wherein the composition according to the invention is applied for at most 9 days, preferably 4 days after application.

Advantageously, the composition according to the invention is applied by foliar or root application. When the composition is applied by root application, for example using a ground drip system, the undiluted quantities administered are of the order of 1 to 8 L per hectare, preferentially 3 to 6 L per hectare.

Foliar application is of particular interest for the treatment of foliage, flowers, or fruit, especially on annual crops such as field crops or, more generally, on open-field crops without drip systems. This application is also of particular interest for perennial crops such as vines and arboriculture, including ornamentals. The quantities administered, comprising the composition diluted in water, are of the order of 50 to 3000 L per hectare, preferentially 50 to 1000 L per hectare.

Root application is preferred when a fertigation system is in place, particularly for greenhouse crops. This application may also be preferred when the product is combined with a ground-applied product.

When root application is preferred, this can be done by soaking, fertigation, or drip irrigation.

When applied by foliar application, the composition is preferably diluted with water to obtain a “slurry”. More preferably, the diluted composition is applied as a slurry. When diluted, the composition is preferentially applied at a rate of 50 to 3000 L, preferentially 50 to 1000 L per hectare. When undiluted, the composition is preferentially applied at a rate of 1 to 8 L per hectare, more preferably 3 to 6 L per hectare.

The invention is now showed by non-limiting examples of compositions according to the invention and by results.

### EXAMPLES

### Example 1—Composition According to the Invention at pH of 1.8-1.7

When undiluted, the composition is composed of phosphoric acid and dihydrogen phosphate (H₃PO₄ and H₂PO₄₋) with a pH of 1.8-1.7. At a pH of 1.8-1.7, the acid form, i.e. phosphoric acid, represents 60% of the mixture, and dihydrogen phosphate represents 40%. The P/K ratio is 6.2:1.

The composition is prepared according to the following method:
a. Mix H3PO4 in H2O water in a tank,
b. Add KH2PO4 and dissolve,
c. May be combined with a magnesium salt, zinc and assimilable silica,
d. Adjust the pH to 1.7-1.8 by adding KOH or H3PO4 to the mixture

### Example 2—Composition According to the Invention at pH of 2.15

When diluted to 1% in water, the composition is composed of phosphoric acid and dihydrogen phosphate (H₃PO₄ and H₂PO₄₋) with a pH of 2.15. At a pH of 2.15, the two forms account for around 50% of the mixture. The acid form, phosphoric acid, represents 295 g/L of the mixture. The P/K ratio is 6.2:1.

The composition is prepared by mixing the composition according to Example 1 in H₂O water in a tank.

### Example 3—Composition According to the Invention at pH of 4

When undiluted, the composition is composed of phosphoric acid and dihydrogen phosphate (H₃PO₄ and H₂PO₄₋) with a pH of 4. At a pH of 4, the acidic form, i.e. phosphoric acid, represents less than 5% of the mixture and dihydrogen phosphate represents more than 95% of the mixture. The P/K ratio is 6.2:1.

The composition is prepared according to the following method:
a. Mix H₃PO₄ in H₂O water in a tank,
b. Add KH₂PO₄ and dissolve
c. May be combined with other ingredients such as fungicides, biostimulants, fertilizers or adjuvants.
d. Adjust the pH to 4 by adding KOH or H₃PO₄ to the mixture.

### Example 4—Composition According to the Invention at pH of 3

When undiluted, the composition is composed of phosphoric acid and dihydrogen phosphate (H₃PO₄ and H₂PO₄₋) with a pH of 3. At a pH of 3, the acid form, i.e. phosphoric acid, represents about 10% of the mixture, and dihydrogen phosphate represents 90%. The P/K ratio is 6.2:1.

The composition is prepared according to the method described in example 3, adjusting the pH to 3.

### Example 5—Composition According to the Invention at pH of 1

When undiluted, the composition is composed of phosphoric acid and dihydrogen phosphate (H₃PO₄ and H₂PO₄₋) with a pH of 1. At a pH of 1, the acid form, i.e. phosphoric acid, represents about 90% of the mixture, while the dihydrogen phosphate form represents 10%. The P/K ratio is 6.2:1.

The composition is prepared according to the method described in example 3, adjusting the pH to 1.

### Example 6—Proteomic Study of Potatoes Grown in a Greenhouse

The mechanism of action of the composition according to example 1 diluted to 2% was studied through proteomic analysis of potatoes, Solanum tuberosum, after foliar treatment with the composition at the 4-leaf stage. The treatment protocol is shown in Table 1 below.

TABLE 1

| Product | D − 14 | D − 9 | D − 7 | D − 2 | D0 | D + 2 | D + 7 |
|---|---|---|---|---|---|---|---|
| Water | | T1 | | T2 | | P | |
| (control) | | | | | | | |
| Invention | | T1 | | T2 | | P | |
| Water | T1 | | T2 | | | P | |
| (control) | | | | | | | |
| Invention | T1 | | T2 | | | P | |
| Water | | T1 | | T2 | I | P | N |
| (control) | | | | | | | |
| Invention | | T1 | | T2 | I | P | N |

T = Treatment
I = Inoculation against late blight
P = Sampling
N = Rating

In this trial, 18 samples were collected, each comprising 8 leaflets. After extraction, a total of 2812 proteins were identified and quantified by mass spectrometry. Of the 2812 proteins, 2036 were identified in all samples. Finally, a pair-wise comparison was used to select 1628 proteins for the proteomic study detailed below.

### Sample Preparation and LC-MS/MS Analysis

Proteins were extracted using the Pierce total plant protein extraction kit (Thermo Fisher) according to the manufacturer's recommendations.

Proteins were mixed with Laemmli buffer and heated at 37° C. for 30 min. Protein concentration was determined by the Bradford method and standardized for all samples. Samples were separated by SDS-PAGE and digested with trypsin overnight. The peptides generated were acidified and separated using a LTQ Orbitrap Fusion LUMOS (Thermo Fisher). Mass spectra were analyzed using Proteome Discoverer (version 2.4). The resulting MS/MS data were searched in the Solanum tuberosum (potato) database (cv. DM1-3 516 R44) UP000011115 (53105 entries). Research parameters were: monoisotopic mass; trypsin as cleavage enzyme; maximum two missed cleavages, cysteine carbamidomethylation as fixed modifications; and N-terminal acetylation and methionine oxidation as variable modifications. Results were filtered on the basis of an FDR≤0.01, and overall peptide scores. Background-based, nested ANOVA was used to test differentially expressed proteins. The analyses were carried out using Proteome Discoverer 2.4. Protein quantification values were exported to Excel for further analysis. These quantification values are presented in appendix 2.

### Bioinformatics and Statistical Analysis

Relevant proteins were classified according to their metabolic pathways using MapMan 3.0.0 (Thimm et al., 2004) and their biological processes using the publicly available Gene Ontology (GO) database provided by the Gene Ontology Consortium (Ashburner et al., 2000). The interactome was analyzed using Cytoscape (Shannon et al., 2003) combined with STRING (Jensen et al., 2009). Known interactions between relevant proteins in treated leaves were used to draw the protein interaction network. Where relevant, BLAST was used to propose a potential identification or annotation for unannotated/unassigned proteins. Proteins with a fold-change of ≤2 or ≤0.50 in expression between samples were considered significant. Protein fold-change values were converted into percentage rates of change between the invention and the control, for sets of proteins belonging to each biological process (cluster).

### Comparative Proteomic Study

In order to study the mechanisms of action due to treatment with the composition according to the invention, the inventors carried out a comparative study of the proteome of greenhouse-grown potato leaves treated with the composition. The treated leaves were compared with water-treated potatoes. The plants were inoculated, or not, with the oomycete Phytophthora infestans, the causal agent of potato late blight, a hemi-biotrophic pathogen. A pool of biological replicates of control and treated leaves was collected on three separate occasions in three independent trials. Proteomic analyses were performed on each pool per treatment. Proteomic analysis returned a total of 34219 high-quality peptides corresponding to 2812 identifiable and quantifiable potato proteins in the samples. For more robust analyses, only proteins identified in the three independent biological replicates in the three trials were selected for quantitative comparative analysis. A summary of proteins detected in healthy treated plants and absent from healthy control plants is also provided. Of the 2812 proteins, 2036 were detected in all samples. Of the 2036 proteins used for pairwise comparisons, global functional annotations could be reliably assigned to 1628 proteins.

### Results

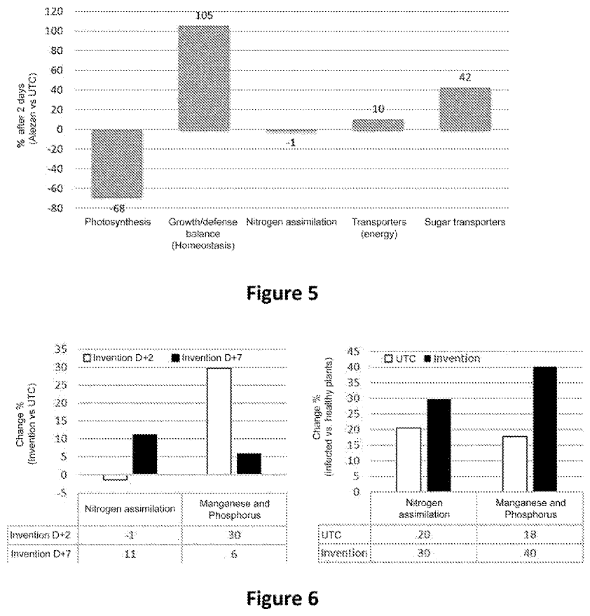

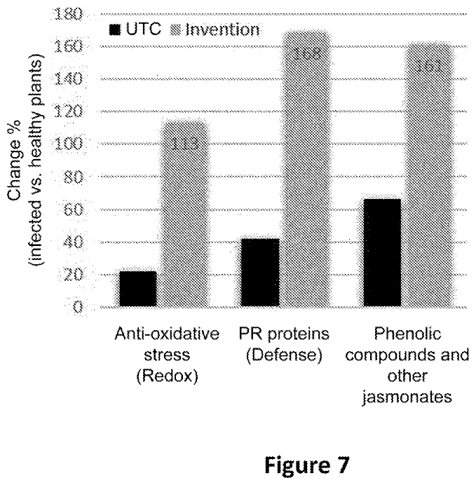

The results are shown in FIGS. 5, 6 and 7.

The composition according to Example 1 diluted to 2% increases the overall abundance of all pathways, and particularly those related to pathogen detection and response, protein synthesis, cell wall organization, redox balance, energy production, phenolic metabolism, and protein modification by glutathione S-transferase activities, which are known to play a role in maintaining normal growth under stress as presented in table 2 below and FIGS. 5 to 7.

TABLE 2

| Glutathione S-transferase (GST) | Invention (% change vs. UTC) |
|---|---|
| class tau GST | 126 |
| class phi GST | 149 |
| class lambda GST | 140 |
| class zeta GST | 95 |
| glutaredoxin | 312 |

A decrease is observed in the abundance of photosynthesis-related proteins. (FIG. 5) The analyses then focused on plant responses to pathogens. The composition according to example 1 strongly induces global defense responses in the absence of pathogen; this includes an increase in the abundance of proteins associated with jasmonic acid (JA) biosynthesis/sensitivity, heat shock proteins, endoglucanases, peroxidases and secondary metabolism of phenolic compounds (FIGS. 5 and 6).

Treating healthy plants with the composition according to example 1 thus increases the overall robustness and resilience potential of potato plants, and acts as a stimulator of plant defenses, capable of inducing a pre-state of defense against pathogens.

The effects of the action of the composition according to example 1 against pathogens are also linked to an increase in protein synthesis linked to redox balance, and to cell wall remodeling. Biosynthesis and/or detection of jasmonic acid and synthesis of secondary phenolic compounds are also enhanced. These changes are supported by increased energy production and sustained homeostasis (FIG. 5).

These results demonstrate that the composition based on acid monopotassium phosphate significantly increases the mechanisms of action linked to plant growth, as well as those linked to improving plant physiology. In particular, it has a positive impact on proteins involved in energy and redox balance, the phytohormone jasmonate, secondary metabolite synthesis, and cell wall reorganization, as well as on proteins involved in pathogen defense. Thus, the composition according to the invention acts as a nutritional product, an elicitor, a biostimulator, including a stimulator of plant defenses and increases the robustness of said plants against pathogens.

### Example 7—Results of an Artichoke Late Blight Trial

The aim of the trial is to evaluate the efficacy of a water-based treatment of the composition shown in example 1 at 2% in comparison with a 0.5% copper fertilizer (Silicopper, 5% copper sulfate) on late blight in artichokes, Bremia lactucae.

The treatment was applied 5 days before disease inoculation, and the percentage of damaged foliage was analyzed 9 days after inoculation. The results are presented in the form of a score as shown in the table below.

TABLE 3
Rating scale

| Score | Interpretation | Score | Interpretation |
|---|---|---|---|
| 0 | Healthy foliage | 6 | 50% damaged foliage |
| 2 | 10% damaged foliage | 8 | 75% damaged foliage |
| 4 | 25% damaged foliage | 10 | Foliage destroyed |

The results are shown in the following table.

TABLE 4

| | Water (control) | Silicopper | Invention |
|---|---|---|---|
| Average disease | 7.2 | 1 | 3.1 |
| index (score) | | | |
| Efficacy against | Nd | 86% | 57% |
| late blight (%) | | | |

The baseline product is known for its specific action on late blight. It has been applied under laboratory conditions with no risk of leaching for this contact product, making the baseline optimally effective. Our composition is therefore significantly effective compared to the trial set-up that was very favorable to the baseline. The composition according to the invention thus has a good efficacy of almost 60% on artichoke late blight.

### Example 8—Results of a Cauliflower Late Blight Trial

The aim of the trial is to evaluate the efficacy of a water-based treatment with the composition shown in example 1 at 2% and the product Bion (acibenzolar-S-methyl 50%) at 0.01%, on late blight in cauliflower, Hyaloperonospora parasitica.

The treatment was applied 5 days before disease inoculation, and the percentage of damaged foliage was analyzed 9 days after inoculation. The results are presented in the form of a score as shown in table 3.

The results are shown in the following table.

TABLE 5

| | Water (control) | BION ® | Invention |
|---|---|---|---|
| Average disease | 6.3 | 0.8 | 1.3 |
| index (score) | | | |
| Efficacy against | nd | 87% | 79% |
| late blight (%) | | | |

The baseline product (BION) is an elicitor known for its performance. However, it is highly disruptive in terms of selectivity, making it difficult to use. The results of this trial show that the composition according to the invention is close to this baseline, with the advantage of bringing no risk of lack of selectivity with respect to the plant. The composition according to the invention has a good efficacy of almost 80% on cauliflower late blight.

### Example 9—Results of a Lettuce Late Blight Trial

The aim of the trial is to evaluate the efficacy of a water-based treatment of the composition shown in example 1 at 2% and the product Ortiva (azoxystrobin 250 g/L) at 0.2%, on late blight in lettuce, Bremia lactucae.

The treatment was applied 5 days before disease inoculation, and the percentage of damaged foliage was analyzed 9 days after inoculation. The results are presented in the form of a score as shown in table 6.

The results are shown in the following table.

TABLE 6

| | Water (control) | Ortiva ® | Invention |
|---|---|---|---|
| Average disease | 7 | 0 | 1 |
| index (score) | | | |
| Efficacy against | no | 100% | 86% |
| late blight (%) | | | |

The composition according to the invention shows a good efficacy of almost 90% on lettuce late blight in comparison with a recognized synthetic fungicide.

### Example 10—Results of an Apple Scab Trial

The aim of the trial is to evaluate the efficacy of the composition according to the invention in combination with a contact product such as copper oxychloride, captan and mancozeb on apple scab in comparison with a baseline systemic fungicide, trifloxystrobin or tebuconazole in combination with one of the above-mentioned contact products.

The treatment was applied 7 times according to the following protocol:
Slurry volume: 1000 L/ha
Average pace: 16 days
Ratings on fruit and leaves (defoliation at the end of the cycle).

The results are presented in table 7 below.

TABLE 7

| | Mar. 13, 2020 | Mar. 20, 2020 | Apr. 2, 2020 | Apr. 23, 2020 |
|---|---|---|---|---|
| Conditions | Product Dose | Product Dose | Product Dose | Product Dose |
| UTC | UTC | | | |
| Baseline | Oxychloride 3 Kg/ha | Captan 1.5 Kg/ha | Mancozeb 2 Kg/ha | Captan 1.2 Kg/ha |
| | | | Trifloxystrobin 0.15 | Tebuconazole 0.6 |
| | | | Kg/ha | Kg/ha |
| Contact | Oxychloride 3 Kg/ha | Captan 1.5 Kg/ha | Mancozeb 2 Kg/ha | Captan 1.2 Kg/ha |
| Invention | Oxychloride 3 Kg/ha | Captan 1.5 Kg/ha | Mancozeb 2 Kg/ha | Captan 1.2 Kg/ha |
| 4 L/ha | Invention 4 L/ha | Invention 4 L/ha | Invention 4 L/ha | Invention 4 L/ha |
| Invention | Oxychloride 3 Kg/ha | Captan 1.5 Kg/ha | Mancozeb 2 Kg/ha | Captan 1.2 Kg/ha |
| 6 L/ha | Invention 6 L/ha | Invention 6 L/ha | Invention 6 L/ha | Invention 6 L/ha |

| | | | |
|---|---|---|---|
| | May 13, 2020 | Jun. 5, 2020 | Jun. 17, 2020 |
| Conditions | Product Dose | Product Dose | Product Dose |

| | |
|---|---|
| UTC | UTC |

| | | | |
|---|---|---|---|
| Baseline | Captan 1.2 Kg/ha | Mancozeb 2 Kg/ha | Captan 1.2 Kg/ha |
| | Trifloxystrobin | Trifloxystrobin | Tebuconazole |
| | 0.15 Kg/ha | 0.10 Kg/ha | 0.6 Kg/ha |
| Contact | Captan 1.2 Kg/ha | Mancozeb 2 Kg/ha | Captan 1.2 Kg/ha |
| Invention | Captan 1.2 Kg/ha | Mancozeb 2 Kg/ha | Captan 1.2 Kg/ha |
| 4 L/ha | Invention 4 L/ha | Invention 4 L/ha | Invention 4 L/ha |
| Invention | Captan 1.2 Kg/ha | Mancozeb 2 Kg/ha | Captan 1.2 Kg/ha |
| 6 L/ha | Invention 6 L/ha | Invention 6 L/ha | Invention 6 L/ha |

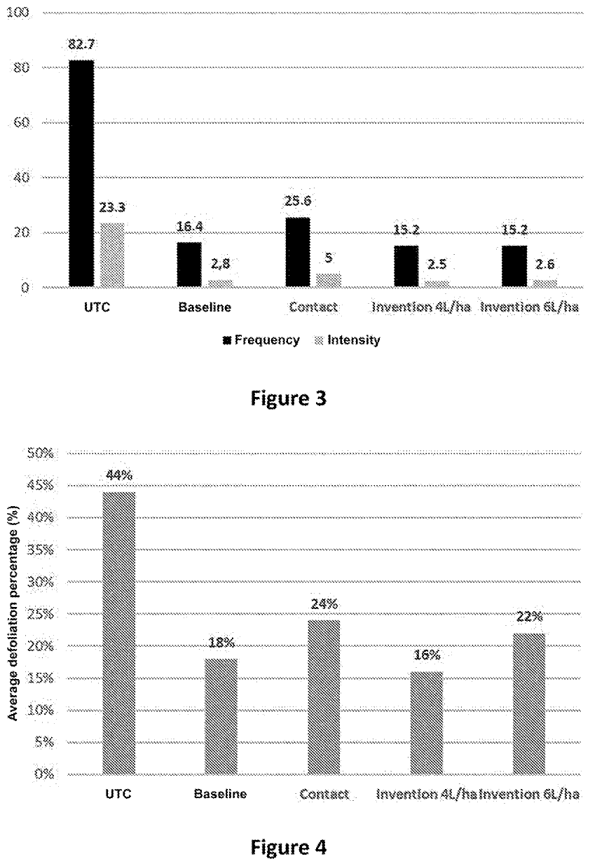

Results for apple scab on fruit are shown in FIG. 3.

On fruit (FIG. 3): The inventors have demonstrated the effect of the composition according to example 1 at 0.4% and 0.6% on the frequency and intensity of attack when used at 4 L/ha and 6 L/ha in combination with contact products. This effectiveness (15% frequency and 2.5% intensity) is equivalent to that of the baseline program based on contact and systemic fungicide products (16.4% frequency and 2.8% intensity). In fact, the combination of contact products with the present composition performs significantly better than contact products used alone (25% frequency and 5% intensity).

On leaves (FIG. 4): The inventors have demonstrated an effect of the composition according to example 1 used at 4 L/ha in combination with contact products. This efficiency (16% defoliation) is equivalent to that of the baseline program based on contact and systemic fungicides (18% defoliation). In fact, the combination of contact products with the present composition performed significantly better than contact products used alone (24% defoliation) compared with 44% in the untreated control. The invention's dose of 6 L/ha shows no difference. Thus, 4 L/ha is sufficient in combination with contact products. This performance is important and will make it easier to set aside reserves for the following season.

Finally, the composition according to example 1 is residue-free, as shown in Table 8 below.

TABLE 8

| | Fosetyl-Al | Phosphonic acid |
|---|---|---|
| Conditions | (mg/kg) | (mg/kg) |
| Invention 4 L/ha | <0.01 | <0.01 |
| Invention 6 L/ha | <0.01 | <0.01 |

Limit of quantification (LOQ): 0.01 ppm.
MRL authorized in the EU: 150 ppm.

### Example 11—Results of a Grapevine Late Blight Trial

The aim of the trial is to assess the efficacy of the composition described in example 1 in combination with the product Maniflow (Bordeaux mixture) against late blight on grapevines at a rate of less than 4 kg Cu/ha/year.

The Merlot plot, comprising 3,300 vines/ha at a rate of 9 vines/plot, was artificially contaminated and not misted. The treatment was applied 4 times according to the following protocol:
Slurry volume: 225 L/ha
Average pace: 8 days
Total dose Cu: 3.870 g
Artificial contamination on May 11, using contaminating ceps.

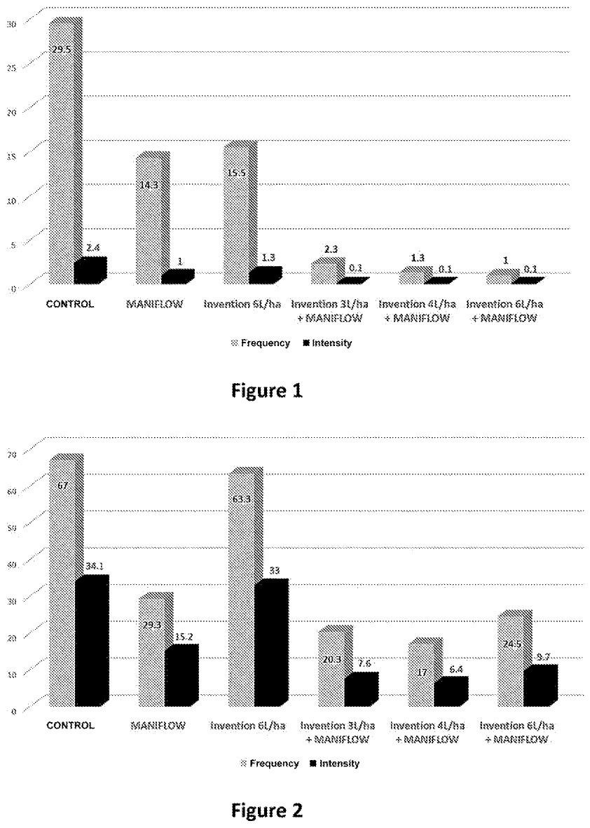

The results are shown in FIG. 1 for grape leaves and FIG. 2 for bunches.

On leaves: The inventors have demonstrated an effect of the composition according to the invention used alone on attack frequency and intensity. This efficacy is equivalent to that of the copper-based baseline product. The inventors have also observed a strong synergistic effect between the combination of the copper-based product and the present composition according to the invention on leaves. In fact, the combination of copper and the present composition performs significantly better than copper alone. The inventors then tested 3 sets of conditions with 3, 4 and 6 L of the composition combined with the copper preparation. They observed a weak effect on attack intensity and frequency between the 3 sets with 3, 4 and 6 L of the composition combined with the copper preparation. Thus, 3 L/ha is sufficient in combination with copper.

On bunches: In contrast to the copper-based baseline product, the composition according to the invention has no effect on attack frequency or intensity when used on its own. Here again, however, there is a strong synergistic effect between the copper-based product and the composition according to the invention on bunches of grapes. The combination of copper and said composition performs significantly better than copper alone. Finally, however, the inventors observed little effect on the intensity and frequency of attack between the 3 modalities at 3, 4 of the composition associated with the copper preparation. A dose of 3 L/ha is sufficient in combination with copper.

### Example 12—Test Result for the Presence of Phosphite Residues after Treatment with the Composition According to Example 1

The composition according to example 1 is prepared as follows. The composition is diluted in water by adding the dose of composition (1 to 8 L/ha) to a sprayer filled to 50% of the volume of water, then mixing by agitation. It is then topped up with additional water while maintaining agitation. The spray mixture is then applied at the intended rate per hectare (50-3000 L/ha), depending on the type of crop, the vegetative stage and the type of sprayer (air-assisted or projected)

The composition according to the invention is applied to grapevines, apple trees, lettuce and potatoes.

The results are presented in tables 9, 10, 11, and 12 below.

TABLE 9

| | | | | Phosphonic |
|---|---|---|---|---|
| Year | Trial Number | Crop | Form | acid residue |
| 2019 | 1 | Grapevine | Invention 4 L/ha | 4.3 +/− 1.4 |
| | | | Phosphite | 22 +/− 7 |
| | | | treatment | |
| | | | Untreated control | 4.5 +/− 1.5 |
| 2020 | 4 | | Invention | 4.4 +/− 0.5 |
| | | | Phosphite | 11 +/− 1 |
| | | | treatment | |
| | | | Untreated control | 3.8 +/− 0.5 |

TABLE 10

| | | | | Phosphonic |
|---|---|---|---|---|
| Year | Trial Number | Crop | Form | acid residue |
| 2020 | 9 | Apple tree | Invention 2 L/ha | 0 |
| 2020 | 9 | Apple tree | Untreated control | 0 |
| 2020 | 10 | Apple tree | Invention 2 L/ha | 0 |
| 2020 | 10 | Apple tree | Untreated control | 0 |

TABLE 11

| | | | | Phosphonic |
|---|---|---|---|---|
| Year | Trial Number | Crop | Form | acid residue |
| 2020 | 8 | Lettuce | Invention 6 L/ha | 0 |
| 2020 | 8 | Lettuce | Untreated control | 0 |

TABLE 12

| | | | | Phosphonic |
|---|---|---|---|---|
| Year | Trial Number | Crop | Form | acid residue |
| 2019 | 3 | PDT | Phosphite treatment 2 L/ha | 6.2 +/− 2.1 |
| 2019 | 3 | PDT | Invention 4 L/ha | 0 |
| 2019 | 3 | PDT | Invention 6 L/ha | 0 |
| 2019 | 3 | PDT | Untreated control | 0 |

The results shown in the tables clearly demonstrate that treatment with the composition according to the invention does not result in any phosphite residues after treatment.

1. A use of a composition comprising a mixture of phosphoric acid and dihydrogen phosphate, in aqueous form, applied to plants as a biostimulant and/or elicitor and/or nutritional product and/or for combating pathogens, characterized in that the pH of said composition is between 1 and 4.

2. The use according to claim 1, characterized in that the pH is less than 2.5.

3. The use according to claim 1, characterized in that the P/K ratio of the composition is between 5.5:1 and 7:1.

4. The use according to claim 1, characterized in that the P/K ratio of the composition is between 6:1 and 6.4:1.

5. The use according to claim 1, characterized in that the composition comprises a mixture consisting of phosphoric acid, dihydrogen phosphate and water.

6. The use according to claim 1, characterized in that the composition does not comprise phosphorous acid and phosphonic acid.

7. The use according to claim 1, characterized in that the composition is used as a biostimulant and elicitor product and nutritional product and for controlling pathogens

8. The use according to claim 1, characterized in that the composition comprises zinc and/or manganese and/or silica.

9. The use according to claim 8, characterized in that the zinc is zinc bis(dihydrogen phosphate) or zinc sulfate.

10. The use according to claim 9, characterized in that the concentration of phosphoric acid is between 5 and 10% and the concentration of zinc bis(dihydrogen phosphate) is between 5 and 10%.

11. The use according to claim 1, characterized in that the mixture is used in combination with a plant protection product and/or biostimulant and/or fertilizer and/or adjuvant.

12. The use according to claim 1, to stimulate plant defenses and/or enhance plant metabolism and/or increase redox balance and/or increase cellular homeostasis and/or increase energy production.

13. A method for treating crops to stimulate plant defenses, wherein the composition of any of claims 1 to 10 is applied for at most 9 days, preferentially 4 days after application.

14. A method for treating crops to stimulate said crops, characterized in that the composition of claim 1 is applied undiluted at a rate of 1 to 8 L per hectare or diluted at a rate of 50 to 3000 L per hectare.

15. The method according to claim 14, characterized in that the composition is applied by foliar or root application.
